(19) United States
(12) Patent Application Publication
(10) Pub. No.: US 2013/0173403 A1
(43) Pub. Date: Jul. 4, 2013

(54) E-RECEIPT BARCODE ON MOBILE DEVICE THAT IS READABLE BY POINT OF TRANSACTION FOR PURCHASE

(71) Applicants: David M. Grigg, Rock Hill, SC (US); Peter John Bertanzetti, Charlotte, NC (US); Tony England, Tega Cay, SC (US); John Franklin Tuders, Harrisburg, NC (US)

(72) Inventors: David M. Grigg, Rock Hill, SC (US); Peter John Bertanzetti, Charlotte, NC (US); Tony England, Tega Cay, SC (US); John Franklin Tuders, Harrisburg, NC (US)

(73) Assignee: BANK OF AMERICA CORPORATION, Charlotte, NC (US)

(21) Appl. No.: 13/342,081

(22) Filed: Jan. 1, 2012

(51) Int. Cl. G06Q 40/00

(52) U.S. Cl. 705/16; 705/35

(57) ABSTRACT

Embodiments of the invention provide a system for maintaining and presenting proof of transaction information. In some embodiments of the invention, the user conducts a return or exchange transaction through the use of a mobile computing device that is capable of communicating with a point of transaction device. In some embodiments, a system is provided that includes: (1) a communication interface (2) a storage device, wherein said storage device comprises an indicia associated with a transaction and used to verify proof of transaction information and (3) a processing device in communication with said communication interface and said storage device, wherein said processing device is configured to: retrieve the indicia associated with a proof of transaction information from said storage device and provide information associated with the indicia associated with the proof of transaction information to said communication interface for output to thereby verify the proof of transaction information.

### FIELD

In general, embodiments of the invention relate to methods, systems, and computer program products for verifying electronic proofs of transactions.

### BACKGROUND

Consumers who interact with various points of transaction, such as a check-out counter, terminal, desk or kiosk can currently elect to receive electronic receipts as a proof of the transactions conducted at these points of transaction. Consumers elect to receive an electronic receipt in lieu of or in addition to a physical receipt for a variety of reasons. An obvious reason for electing to receive an electronic receipt is to eliminate the use of paper. Other reasons for electing an electronic receipt may include the convenience of storage and access, portability and transferability, preservation of natural resources, and for other less obvious reasons. A consumer may receive the electronic receipt by various electronic means including e-mail or via stationary or mobile computing device with means to receive the electronic receipt. It appears to be a continuing trend for consumers to utilize their mobile devices more and more for day-to-day functions and transactions, and therefore, it is possible and likely that the use of electronic receipts will become common place and may some day obviate the need for paper receipts for many commonplace transactions. Elimination of physical receipts may present a myriad of issues for the point of transaction merchant as well as the consumer. For instance the common method of verifying a receipt prior to allowing a return or exchange or processing requests related to a past transaction are obscured due to the nature of an electronic receipt. Moreover, because the electronic receipt is in an electronic form it creates an increased opportunity for electronic receipt fraud or manipulation. Therefore, there remains a need for a system for assisting a consumer to present an electronic receipt or similar proof of transaction and have it verified by a point of transaction.

### SUMMARY OF SELECTED EMBODIMENTS OF THE PRESENT INVENTION

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention relate to methods, systems and a computer program product for verifying an electronic receipt. As a specific example, a consumer may engage in a return transaction with a merchant and provide as proof of the original transaction an electronic receipt. The merchant may then prompt the consumer for some sort of an indicia or verification data that may enable the merchant to verify the electronic receipt. Following the prompt, the consumer may use her mobile phone to retrieve the indicia, as required by the merchant, from a storage device on her mobile. The consumer may then provide this indicia to the merchant in a machine-readable format that can be scanned or otherwise read by the merchant in order to verify the electronic receipt. Once the merchant uses the indicia to verify the electronic receipt, the consumer and merchant may then proceed with the return transaction.

Accordingly, embodiments of the present invention enable merchants who operate a point of transaction and their consumers to cooperate to verify electronic proofs of transaction before a purchase return, exchange or transaction reversal or similar types of transactions are authorized and/or completed. This achieves at least two important objectives. First, this cooperation encourages consumers to continue to elect receiving electronic receipts as proof of transaction without the disruption of printing and storing proofs of transaction. In addition, this cooperation may help reduce the total number of illegitimate transactions that are declined for reasons of possible fraud or inability to verify authenticity of proofs of transactions.

In some embodiments, a system for maintaining and presenting proof of transaction information comprising (a) a communication interface (b) a storage device, wherein said storage device comprises an indicia associated with a transaction and used to verify proof of transaction information and (c) a processing device in communication with said communication interface and said storage device, wherein said processing device is configured to: retrieve the indicia associated with a proof of transaction information from said storage device and provide information associated with the indicia associated with the proof of transaction information to said communication interface for output to thereby verify the proof of transaction information.

In some embodiments, a method for maintaining and presenting proof of transaction information comprising (a) providing information associated with a proof of transaction information (b) receiving a prompt for a user to provide verification data associated with the proof of transaction information (c) retrieving, using a processing device, an indicia associated with the proof of transaction information and (d) providing the indicia associated with the proof of transaction information for verification.

In some embodiments, a computer program product comprising a non-transitory computer readable medium is provided, wherein the non-transitory computer readable medium comprises one or more computer-executable program code portions that, when executed by a computer, cause the computer to (a) provide information associated with a proof of transaction information (b) receive a prompt for a user to provide verification data associated with the proof of transaction information (c) retrieve an indicia associated with the proof of transaction information and (d) provide the indicia with proof of transaction information for verification.

### BRIEF DESCRIPTION OF THE DRAWINGS

Having thus described embodiments of the invention in general terms, reference will now be made the accompanying drawings, wherein:

FIG. 1 is a flow diagram illustrating a general process flow for providing verification of proof of transaction information, in accordance with an embodiment of the invention;

FIG. 2 is a flow diagram illustrating a more-detailed process flow of an embodiment for providing proof of transaction verification, in accordance with an embodiment of the invention;

FIG. 3 provides a block diagram illustrating an system and environment configured to perform proof of transaction verification, in accordance with an embodiment of the invention;

FIG. 4 provides a block diagram illustrating the user's mobile computing device of FIG. 3, in accordance with an embodiment of the invention;

FIG. 5 provides a block diagram illustrating the point of transaction's computer system of FIG. 3, in accordance with an embodiment of the invention;

FIG. 6 provides a block diagram illustrating the point of transaction computer system of FIG. 3, in accordance with an embodiment of the invention;

FIG. 7 is a mixed block and flow diagram of a system configured to perform proof of transaction verification, in accordance with an embodiment of the invention.

### DETAILED DESCRIPTION OF EMBODIMENTS OF THE PRESENT INVENTION

Embodiments of the present invention will now be described more fully hereinafter with reference to the accompanying drawings, in which some, but not all, embodiments of the invention are shown.

In general, according to some embodiments of the present invention, a consumer first conducts a transaction at a point of transaction. During the course of the transaction, it is determined that an electronic receipt together with some indicia for electronic receipt verification should be sent to a memory or storage device that is associated with the consumer that stores the electronic receipt. This could happen in a number of ways. First, the point of transaction may simply inquire as part of the transaction if the consumer would like an electronic receipt, in which case the consumer could respond in the affirmative and provide the point of transaction with the appropriate location to receive the electronic receipt. This may be somewhat inefficient as it holds both the vendor and the consumer at the point of transaction during this step. In other embodiments, the consumer has an account with the point of transaction (such as a preferred buyer account, online account or the like). In such embodiments, the consumer's preference for electronic receipts and the preferred storage locations is stored on the consumer account. Therefore, each time the consumer conducts a transaction with the point of transaction using the account, an electronic receipt together with some indicia for electronic receipt verification is automatically sent to the consumer's storage device or storage method of choice (e.g., memory of mobile computing device, storage device of the point of transaction, cloud storage associated with the user or point of transaction, financial institution storage device associated with the user, etc.). Now, when the consumer intends to conduct another transaction in which the receipt of the original transaction is needed, the consumer can using her mobile device to commence the transaction by electronically providing the proof of transaction and the indicia associated with the proof of transaction to the point of transaction or merchant for verification. Once the point of transaction processes verifies the proof of transaction and indicia, the consumer can continue with the second transaction.

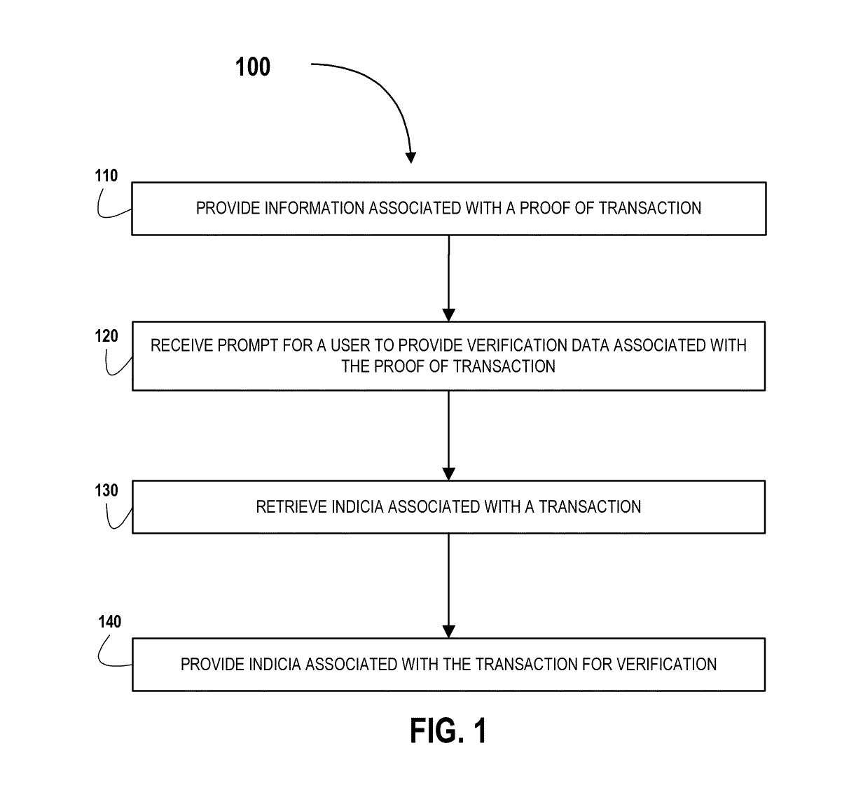

Referring now to FIG. 1, a general process flow 100 is provided for verifying a proof of transaction at a point of transaction. In some embodiments, the process flow 100 is performed by a system (i.e., one or more apparatuses) having hardware and/or software configured to perform one or more portions of the process flow 100. In such embodiments, as represented by block 110, the system is configured to provide information associated with a proof of transaction. As represented by block 120, the system is also configured to receive a prompt for the consumer to provide verification data associated with the proof of transaction. As represented by block 130, the system is also configured to retrieve an indicia associated with a proof of transaction. Lastly, as represented by block 140, the system is configured to provide the indicia associated with the proof of transaction to the point of transaction for verification.

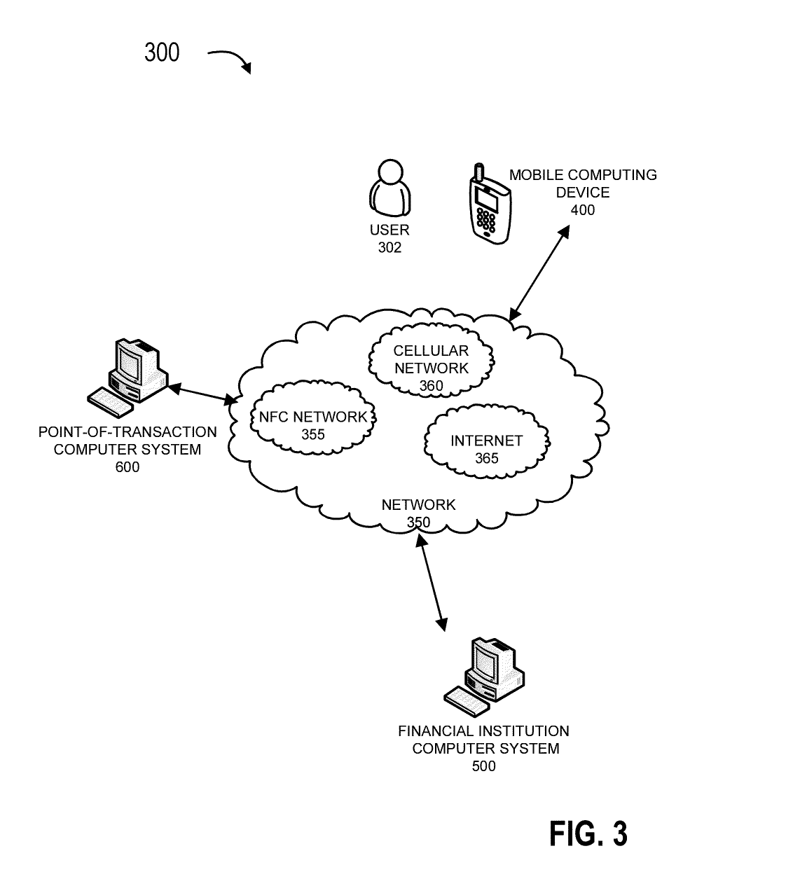

It will be understood that the system having the process flow 100 can include one or more separate and/or different apparatuses. For example, in some embodiments, one apparatus (e.g., mobile computing device 400 described in connection with FIG. 3) is configured to perform the portions of the process flow 100 represented by block 110-140. However, in some other embodiments, a first apparatus (e.g., a mobile computing device 400 described in connection with FIG. 3) is configured to perform the portions of the process flow 100 represented by block 110 and 120 and a second apparatus (e.g., financial institution computer system 500 described in connection with FIG. 3) is configured to perform portions of process flow 100 represented by block 130 and 140.

Regarding block 110, the phrase “proof of transaction information” means any type data or information associated with a user transaction. In some embodiments, the proof of transaction information includes the date, time, form of payment, and merchant location. In some embodiments, the transaction is one in which a user has purchased certain goods or services from another party, such as a merchant. In other embodiments, the user may have received money or other funds from a third party or transferred money or other funds to a third party. As one skilled in the art will appreciate, the phrase “proof of transaction information” can be any type of proof that evidences any type of transaction in which goods, services, money, and/or other items of value are exchanged between two or more individuals or entities (e.g., receipt, bill of sale, paid invoices, etc.). In some embodiments, the proof of transaction information is an electronic receipt provided to the consumer or a device capable of receiving the proof of transaction associated with the consumer.

In some embodiments, the transaction may require the user to approach a point of transaction device, such as a point of transaction computer system and/or payment terminal. In some embodiments, the point of transaction computer system may comprise a cash register and/or payment terminal or a return and/or exchange terminal. In other embodiments, the payment terminal may be a separate point of transaction device. In some embodiments, the payment terminal provides the user with functionality to conduct a transaction or transaction return, such as functionality to present proof of transaction information, swipe a credit card, functionality to swipe a debit card, functionality to input a PIN number or other data used to verify a proof of transaction, and/or functionality to use the e-wallet capability or other application of a mobile computing device. In other embodiments of the invention, a payment terminal comprises only a device capable of communicating with a mobile device.

In some embodiments, the point of transaction may comprise a near field communication payment terminal. In these embodiments, where the user's mobile computing device (also referred to herein as a “mobile device”) is equipped with e-wallet functionality or a mobile application, a user may tap or physically touch the user's mobile computing device against the near field communication terminal to initiate the transaction or transaction return. In some embodiments, a user may tap the user's mobile computing device against the near field communication terminal in order to pay for goods and/or services or receive a refund or merchant credit for a transaction return. In other embodiments, a user may tap the user's mobile computing device against the near field communication terminal in order to send or receive money or other funds. In other embodiments, the user may not tap or physically touch the user's mobile computing device against the point of transaction in order to interact with the point of transaction. In yet some other embodiments, the point of transaction may use any other type of communication protocol other than near field communication technology to enable a user to use the e-wallet functionality or mobile application of the user's mobile computing device.

In some embodiments of block 110 the transaction may involve the user's mobile computing device communicating with the point of transaction device over a network. In some embodiments, the user's mobile computing device and the point of transaction device communicate over a wireless network, such as a cellular communication network, near field communications network, Bluetooth network, and/or another wireless network. In some other embodiments, the transaction may involve the user's mobile computing device and the point of transaction device communicating over a wireline network. In other embodiments, a user may verbally provide the information to a person associated with the point of transaction.

Further concerning block 110, the phrase “information associated with a proof of transaction” means any quantity and/or type of information associated with a proof of transaction. In some embodiments, the information associated with a proof of transaction may be data evidencing a past transaction or proof of payment for goods or services (e.g., a receipt, electronic receipt, bill of sale, gift receipt, etc.). In some embodiments, the information associated with a proof transaction involving a user may be a request to return, reverse or exchange a good or service related to the proof of transaction. In some embodiments, the request is sent from a user mobile computing device. In some other embodiments, the request is inputted by the user of the system configured to perform process flow 100. In other embodiments, the information associated with a proof of transaction may be a notification that the user has commenced the transaction, which in some embodiments, may be sent from a mobile computing device. In other embodiments, the information associated with a proof of transaction involving a user may be a notification that the user and/or the system is physically located near a point of transaction device. In some embodiments of the invention, the information associated with a proof of transaction may be date of purchase, time of purchase, form of payment, or merchant location associated with the transaction associated with the proof of transaction. In some other embodiments of the invention, the information associated with the proof of transaction may be information that identifies the user, such as the user's name, bank account number, debit card number, credit card number, or telephone number, etc.

Lastly, at block 110, the system configured to perform the process flow 100 may “provide” the information associated with a proof of transaction according to a point of transaction using any method known to one skilled in the art. In some embodiments, the system provides the information over a wireless network, such as a cellular communications network, near field communications network, Bluetooth network and/or another wireless network. In some other embodiments, the system may provide the information over a wireline network. In some embodiments of the invention, the system is configured to provide the information associated with a proof of transaction may be a mobile computing device, such as mobile computing device 400 of FIG. 3. In such embodiments, mobile computing device 400 may provide the information associated with a proof of transaction to a point of transaction device, such a point of transaction computer system 600 from FIG. 3 and/or payment terminal. In other embodiments, mobile computing device 400 may provide the information associated with a proof of transaction to another device that can communicate with mobile computing device 400 over a network, such as financial institution computer system 500 from FIG. 3, wherein the financial institution is associated with the user. In yet some other embodiments, the mobile computing device may provide information associated with a proof of transaction via a user's interaction with the mobile computing device (e.g., opening a mobile application, etc.).

In some embodiments, particularly where a mobile computing device is configured to perform process flow 100, the mobile computing device may provide information associated with a proof of transaction before the user commences the transaction. For example, in some embodiments, the user may open a verification application on the mobile computing device that allows the user to provide verification data that may include indicia associated with the proof of transaction while still waiting in line to access a point of transaction device. In some embodiments, the mobile computing device may receive an indication from a point of transaction device (via a NFC, Bluetooth or other wireless communication protocol) that the mobile computing device is within the proximity of a point of transaction device. The mobile computing device may provide information associated with a proof of transaction while the user is waiting in line to access the point of transaction device. However, in some other embodiments, the mobile computing device may provide the information associated with the proof of transaction after the user commences the transaction. For example, the mobile computing device may provide the information associated with a proof of transaction after the user has bumped, tapped or otherwise physically touched the mobile computing device to a NFC payment terminal (or other payment terminals with similar e-wallet functionality).

With regard to block 120, the user may receive a prompt from the point of transaction to provide verification data associated with the proof of transaction information using any known methods. In some embodiments, where the system configured to perform process flow 100 is a mobile computing device, the mobile computing device may display a dialog box or other graphical indicator that prompts the user to provide verification data associated with the proof of transaction. In other embodiments, the point of transaction may display a dialog box or other graphical indicator that prompts the user to provide verification data associated with the proof of transaction. In other embodiments, the mobile computing device may emit a sound or instructions so as to alert the user to provide verification data associated with the proof of transaction. In other embodiments, the system configured to perform process flow 100 may receive a prompt from the point of transaction to provide verification data associated with the proof of transaction by calling the mobile computing device associated with the proof of transaction, sending an email to an account associated with the proof of transaction, or sending a text message to a mobile computing device associated with the proof of transaction.

In some embodiments of the invention, the point of transaction may prompt the user's mobile computing device to provide verification data associated with the proof of transaction before the user has commenced the transaction (i.e., while the user is waiting in line to access a point of transaction device, etc.) and in other embodiments of the invention, the point of transaction may prompt the mobile computing device to provide verification data associated with the proof of transaction after the user has commenced the transaction (i.e., after the user has tapped, bumped or otherwise physically touched a mobile device to a NFC payment terminal, etc.)

Further, in connection with block 130, the system configured to perform process flow 100 may retrieve the indicia through any method and/or functionality known to one of skill in the art. In some embodiments of the invention, the system configured to retrieve the indicia associated with the proof of transaction information may be a mobile computing device, such as mobile computing device 400 of FIG. 3. In such embodiments, mobile computing device 400 may retrieve the indicia associated with the proof of information from a storage device within the mobile computing device. In other embodiments, mobile computing device may retrieve the indicia associated with the proof of transaction information from another device that can communicate with mobile computing device 400 over a network, such as financial institution computer system 500 from FIG. 3 or a point of transaction device computing system 600 from FIG. 3 and/or a payment terminal. In yet some other embodiments, the mobile computing device may retrieve the indicia associated with a proof of transaction via a user's interaction with the mobile computing device (e.g., opening a mobile application, etc.). For example, the system may retrieve the indicia by allowing a user to interact with the system and output the indicia through the use of a keyboard, keypad, touch screen, voice command, mouse and/or similar functionality. Lastly, in some embodiments, the system retrieves the indicia over a wireless network, such as a cellular communications network, near field communications network, and/or another wireless network. In some other embodiments, the system may retrieve the indicia over a wireline network, including without limitation a wireline network that connects input functionality, such as a keyboard or touch screen, etc. to a processing device or memory device.

In some embodiments of the invention, the mobile computing device may retrieve the indicia associated with a proof of transaction before the user has commenced the transaction (i.e., while the user is waiting in line to access a point of transaction device, etc.) and in other embodiments of the invention, the mobile computing device retrieves the indicia after the user has commenced the transaction (i.e., after the user has tapped, bumped or otherwise physically touched a mobile device to a NFC payment terminal, etc.).

At block 130 of process flow 100 the term “indicia” means any quantity and/or type of data that can be used to verify proof of transaction information. In some embodiments, the indicia may be verification data extracted from the proof of transaction information. In other embodiments, the indicia comprise verification data that is separate from the proof of transaction information. In other embodiments, the indicia comprise a unique identifier, wherein the unique identifier identifies the transaction associated with the proof of transaction information. In some embodiments, the indicia may be a unique number associated with the proof of transaction information and original transaction. In other embodiments, the indicia may be used to generate a barcode readable by a point of transaction device. In some embodiments, the indicia may be used to generate a quick response (QR) code readable by a point of transaction device. In other embodiments, the indicia is appended to the proof of transaction information provided to the user. In other embodiments, the indicia is a separate unique identifier (e.g., a pin, alphanumeric number). In other embodiments, the indicia comprise a portion of information extracted from the proof of transaction together with a unique identifier. In other embodiments, the indicia may be used by the point of transaction device to retrieve the transaction associated with the indicia and proof of transaction. In some embodiments, the indicia may be a link to proof of transaction information on a point of transaction database. As one skilled in the art would appreciate, any embodiments of the indicia can be communicated to the point of transaction, represented in a form readable by a point of transaction device or computing device, or communicated to a display element readable by a point of transaction or computing device.

In connection with block 140, the system configured to perform the next step of process flow 100 may use any method to “provide” the indicia associated with the proof of transaction data. In some embodiments of the invention, the system may provide the indicia associated with the proof of transaction information over a wireless network, such as a cellular communications network, near field communications network, and/or another wireless network. In some other embodiments, the system may provide the indicia associated with the proof of transaction information over a wireline network. In some embodiments, where a mobile computing device is configured to perform process flow 100, the mobile computing device may provide the indicia associated with a proof of transaction information to a point of transaction device, such as a point of transaction computer system 600 from FIG. 3. In other embodiments, the mobile computing device may provide the indicia associated with the proof of transaction information to any other device configured to communicate with the mobile computing device over a network, such financial institution computer system 500 from FIG. 3. In other embodiments, the mobile computing device may provide the indicia associated with the proof of transaction to the point of transaction separately from the proof of transaction. In some embodiments, the mobile computing device may provide the indicia associated with the proof of transaction to the point of transaction by appending the indicia to the proof of transaction information. In some embodiments, the mobile computing device may provide the indicia associated with the proof of transaction to the point of transaction via a text message. In other embodiments, the mobile computing device may provide the indicia associated with the proof of transaction contemporaneously with the proof of transaction information. In other embodiments, wherein the mobile computing device provides the indicia contemporaneously with the proof of transaction information, the display element embodying the indicia readable by a point of transaction device may also comprise information associated with the proof of transaction information. Although, not shown in the figures, in some embodiments wherein the mobile computing device is performing a portion of process flow 100, the mobile computing device may also transmit other information that the point of transaction may require to complete the transaction (e.g., electronic signature, other relevant metrics, etc.).

Further, in connection with block 140, in some embodiments where a mobile device is configured to perform process flow 100, the mobile computing device may be configured to provide a display or dialog box displaying the indicia therein. In some embodiments, the mobile computing device is configured to provide the indicia to a display as a electronically readable bar code readable by a point of transaction device. In other embodiments, the mobile computing device provides the indicia to a display as rendering of a media file comprising the indicia readable by a point of transaction device. In some embodiments, the media file may be an image file, video file, or a voice file. In some embodiments, the user selects her preferences for the type of media file she would like presented to the point of transaction. In some embodiments, the mobile computing device provides the indicia to a display as a rendering of a media file comprising the indicia identifiable by a person. In some embodiments, the rendering of a media file comprising the indicia is readable by a person associated with the point of transaction. In other embodiments, the mobile computing device may also provide a customer loyalty card contemporaneously with the indicia. Thus, the user could show or otherwise provide the indicia, image or bar code to the point of transaction device in order to verify the proof of transaction. As one of skill in the art will appreciate, the mobile computing device could be configured to display an indicia, unique identifier number, image or bar code that when scanned, or “read” by the point of transaction device, provides a notification to the point of transaction device that the proof of transaction is verified.

As used herein, the term “financial institution” refers to an institution that is associated with the user. Financial institutions can include, but are not limited to, banks, building societies, credit unions, stock brokerages, asset management firms, savings and loans, money lending companies, insurance brokerages, insurance underwriters, dealers in securities, and similar businesses. In some embodiments, the financial institution may be a bank that issued the user's credit card or debit card or offers a system for maintaining and managing proof of transaction information such as an electronic receipt. In other embodiments, the financial institution may be where the user has a financial institution account. In yet some other embodiments, the term financial institution may refer to a third party that stores information used to verify proof of transaction information.

As discussed below, in some embodiments of block 140, the system may provide the indicia. In some embodiments of block 140, a mobile computing device provides the indicia associated with a proof of transaction to a point of transaction device. Although not depicted in process flow 100, the point of transaction device may subsequently determine whether the indicia is correct or not. The point of transaction device may use any method to determine if the indicia is correct or not. Upon receiving the indicia, the point of transaction computer system may compare the indicia to stored information about the transaction associated with the proof of transaction. The stored information may comprise information that is necessary to verify a proof of transaction that may have been stored at an earlier point in time. If the indicia matches the stored information (which may be stored in a memory device that is accessible to the third party computer system), then the indicia is correct and the proof of transaction is verified. In some embodiments, the point of transaction device may send (via wireless or wireless communication channels) verification data to a financial institution computer system in order to verify that the indicia is correct or not. In some embodiments, the financial institution computer system may subsequently send an indication to the point of transaction device and/or mobile computing device that the indicia is correct and the proof of transaction is verified.

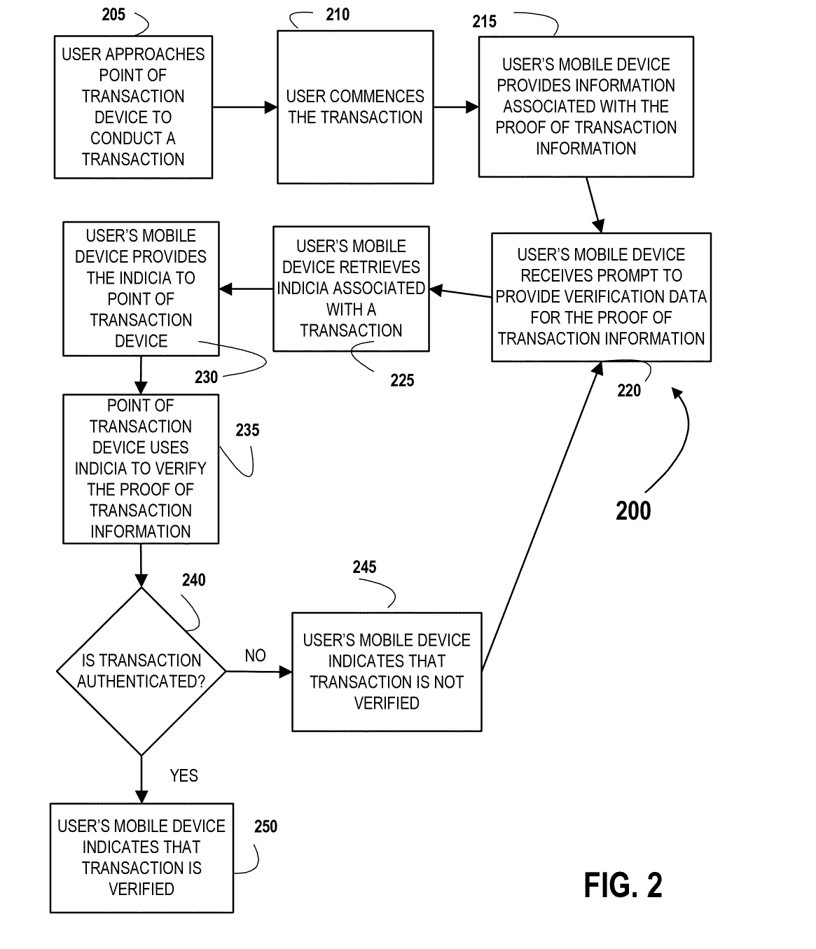

Referring now to FIG. 2, a more detailed process flow 200 is presented for verifying a proof of transaction at a point of transaction, in accordance with an embodiment of the present invention. In some embodiments, one or more of the portions of process flow 200 are performed by an apparatus having hardware and/or software configured to perform one or more portions of process flow 200. In some of these embodiments, the apparatus configured to perform process flow 100 is also configured to perform process flow 200. As such, it will be understood that process flow 200 illustrated in FIG. 2 may include embodiments of the process flow 100 discussed in connection with FIG. 1.

As represented by block 205, a user approaches a point of transaction device to conduct a transaction. In some embodiments of the invention, the user approaches a point of transaction device to return or exchange goods or services that were sold and/or provided by a merchant. In other embodiments of the invention, the user approaches a point of transaction device configured to either send money or other funds to a third party and/or receive money or funds from a third party. As one of skill in the art will appreciate the user may approach the point of transaction device may be capable of conducting any type of transaction and may use any means to verify the proof of transaction. Additionally, the system may employ any type of functionality, including without limitation a keypad, touch screen, retina scanner, fingerprint scanner, or voice analysis software to perform the verification.

In other embodiments of block 205, the point of transaction device comprises a point of transaction computer system. In some embodiments, the point of transaction computer system may comprise a returns and/or exchanges terminal and a cash register and/or payment terminal. The cash register and/or payment terminal may also have returns and/or exchanges capabilities. In some embodiments, the payment terminal provides the user with functionality to conduct a transaction. Further, the payment terminal may comprise a near field communication payment terminal or any other type of communication terminal that can communicate with a mobile computing device over a network.

At block 210, the user commences the transaction. In other embodiments, the user uses a mobile computing device, including but not limited to a mobile phone, to commence the transaction. In these embodiments, the mobile computing device may be configured to perform e-wallet functionality or some other mobile application that would enable the user to commence transactions through the use of the mobile computing device. In other embodiments, the mobile computing device may be configured to process a mobile application that would enable the user to commence transactions through the use of the mobile computing device.

In some embodiments of the invention, where the payment terminal comprises a near field communication terminal, the user may commence the transaction by tapping, touching, or physically pressing the mobile computing device to the payment terminal. In other embodiments, the user may use other wireless communication protocols, such as Bluetooth or a wireless internet connection, to commence the transaction through the use of a mobile computing device. In yet some other embodiments, the user may use a wireline communication network to commence the transaction through the use of a mobile computing device.

Returning back to block 210, in some embodiments of the invention, the user may commence the transaction by swiping a credit card or debit card. In other embodiments of the invention, the user swipes the credit card or debit card at a payment terminal. In other embodiments, a third party, such as the employee of a store, swipes the credit card or debit card.

At block 215, subsequent to the user commencing the transaction, the user's mobile computing device provides information associated with a proof of transaction. In some embodiments of the invention, the user's mobile computing device provides information associated with the proof of transaction to a point of transaction device, which may comprise a point of transaction terminal. In other embodiments the user's mobile computing device may provide the information associated with the proof of transaction to a device that may communicate with the mobile computing device over a network, such as a computer system associated with the user's financial institution. The mobile computing device may provide information associated with the proof of transaction via a wireless or wireline communication network.

In some embodiments of the invention, the information associated with the proof of transaction is an indication that the user commenced the transaction at block 210. In other embodiments of the invention, the information associated with the transaction may be a request that the point of transaction commence the verification of a proof of transaction. In still other embodiments of the invention, the information associated with the proof of transaction is any other type of information relating to the proof of transaction, including without limitation, the user's credit card number, the user's debit card number, the user's name, the user's address, other information about the user or the user's bank account number.

At block 220, the user receives a prompt from the point of transaction device for the user to provide verification data associated with the proof of transaction. The user may receive the prompt to provide verification data from the point of transaction using any known method. In some embodiments, the point of transaction comprises a point of transaction device that may display a dialog box or other graphical interface to prompt the user to provide verification data associated with the proof of transaction. In other embodiments, the user's mobile computing device may receive a communication from a point of transaction device prompting the user to provide verification data associated with the proof of transaction.

At block 225, the mobile computing device retrieves the indicia associated with a proof of transaction information through any method and/or functionality known to one of skill in the art. In some embodiments of the invention, the system configured to retrieve the indicia associated with the proof of transaction information may be a mobile computing device, such as mobile computing device 400 of FIG. 3. In such embodiments, mobile computing device 400 may retrieve the indicia associated with the proof of information from a storage device within the mobile computing device. In other embodiments, the mobile computing device may retrieve the indicia associated with the proof of transaction information from another device that can communicate with mobile computing device 400 over a network, such as financial institution computer system 500 from FIG. 3 or a point of transaction device computing system 600 from FIG. 3 and/or a payment terminal. In yet some other embodiments, the mobile computing device may retrieve the indicia associated with a proof of transaction via a user's interaction with the mobile computing device (e.g., opening a mobile application, etc.). For example, the system may retrieve the indicia by allowing a user to interact with the system and output the indicia through the use of a keyboard, keypad, touch screen, voice command, mouse and/or similar functionality. Lastly, in some embodiments, the system retrieves the indicia over a wireless network, such as a cellular communications network, near field communications network, and/or another wireless network. In some other embodiments, the system may retrieve the indicia over a wireline network, including without limitation a wireline network that connects input functionality, such as a keyboard or touch screen, etc. to a processing device or memory device.

At block 230, the mobile computing device provides the indicia, which it retrieved at block 225, to the point of transaction device. The mobile computing device provides the indicia to the point of transaction device via a network. As discussed above in relation to block 205, in some embodiments of the invention, the point of transaction device may comprise a payment terminal. In some further embodiments the payment terminal may comprise a near field communication payment terminal that can communicate with the mobile computing device over a near field communication network. In still some other embodiments, the payment terminal may communicate with the mobile computing device via other types of wireless networks and/or wireline networks.

At block 235, the point of transaction device receives the indicia associated with the proof of transaction and uses the indicia to verify the proof of transaction. In some embodiments of the invention, the point of transaction device verifies the electronic receipt by comparing the indicia to data associated with the original transaction located on the point of transaction computer system. The point of transaction may subsequently determine that the electronic receipt is valid based, at least partially, on the comparison of the indicia to the data associated with the original transaction. In another embodiment of the invention, the point of transaction device may use the indicia to retrieve the original transaction associated with the proof of transaction from its system or another system storing the information associated with the original transaction. In some embodiments of the invention, the point of transaction device may send the indicia to a financial institution computer system. In those cases, upon receiving the indicia, the financial institution computer system may compare the indicia to stored information of the user in order to verify the electronic receipt. The stored information may comprise proof of transaction information that is necessary to verify the proof of transaction provided by the user which may have been stored at an earlier point in time. If the indicia matches the stored information (which may be stored in a memory device that is accessible to the computer system), then the indicia is correct and the transaction is verified. Similarly, the point of transaction may send the indicia received from the user's mobile device to a remote storage device comprising data used to determine whether the indicia is correct.

In some embodiments of block 235, the point of transaction device sends the indicia to the financial institution computer system via a communications network, which may be either wireless and/or wireline. Similarly, the financial institution computer system may send an indication of whether the indicia is correct or not (i.e., is the transaction verified) to the point of transaction device and/or mobile computing device via a wireless and/or wireline communications network.

At block 240, if the indicia that was received by the point of transaction device at block 225 does not match with the data at point of transaction system or financial institution system, then the proof of transaction is not verified and the process flow 200 moves to block 245. At block 245, the user's point of transaction device indicates that the proof of transaction is not verified. In some embodiments of block 245, the point of transaction device sends information to the mobile computing device that notifies the mobile computing device that the proof of transaction is not verified. In some embodiments of the invention, the point of transaction device sends this information to the mobile computing device via a near field communication network. In other embodiments, the point of transaction device sends this information to the mobile computing device via a different type of wireless network and/or a wireline network. In still some other embodiments, the financial institution computer system sends information to the mobile computing device that notifies the mobile computing device that the proof of transaction is not verified. Upon receiving the information that the proof of transaction is not verified, the mobile computing device indicates to the user the proof of transaction is not verified. The mobile computing device may use any known method to indicate to the user that the proof of transaction is not verified. In some embodiments, the mobile computing device may display a dialog box or other graphical interface to indicate that the proof transaction is not verified. In other embodiments, the mobile computing device may emit a sound and/or vibrate to indicate that the proof of transaction is not verified.

Further, in some embodiments of block 245, if the mobile computing device indicates that the transaction is not verified, the process flow may return to block 220, where the user's mobile computing device receives a prompt for the user to provide verification data to verify the proof of transaction. The process flow may then repeat the processes of block 220 to 240 any number of times until the user verifies the proof of transaction.

Returning back to block 240, if the indicia that was retrieved by the user at block 225 is correct, then the proof of transaction is verified and the process flow 200 moves to block 250. At block 250, the user's mobile computing device indicates that the proof of transaction is verified. In some embodiments of block 250, the point of transaction device sends information to the mobile computing device that notifies the mobile computing device that the proof of transaction is verified. In still some other embodiments, the financial institution computer system sends information to the mobile computing device that notifies the mobile computing device that the proof of transaction is verified. Upon receiving the information that the proof of transaction is verified, the mobile computing device indicates to the user as such. The mobile computing device may use any known method to indicate to the user that the proof of transaction is verified. In some embodiments, the mobile computing device may display a dialog box or other graphical interface to indicate that the proof of transaction is verified. In other embodiments, the mobile computing device may emit a sound and/or vibrate to indicate that the proof of transaction is verified. Once the electronic receipt is verified, the consumer and point of transaction merchant may then continue with the new transaction.

FIG. 3 provides a block diagram illustrating a system and environment 300 for verifying a proof of transaction at a point of transaction, in accordance with an embodiment of the invention. As illustrated in FIG. 3, the transaction verification environment 300 includes a user 302. The environment 300 also includes a mobile computing device 400 belonging to user 302. As used herein, a “mobile computing device” is any mobile communication device, such as a cellular telecommunications device (i.e., a cell phone or mobile phone), personal digital assistant (PDA), a mobile Internet accessing device, or other mobile computing device.

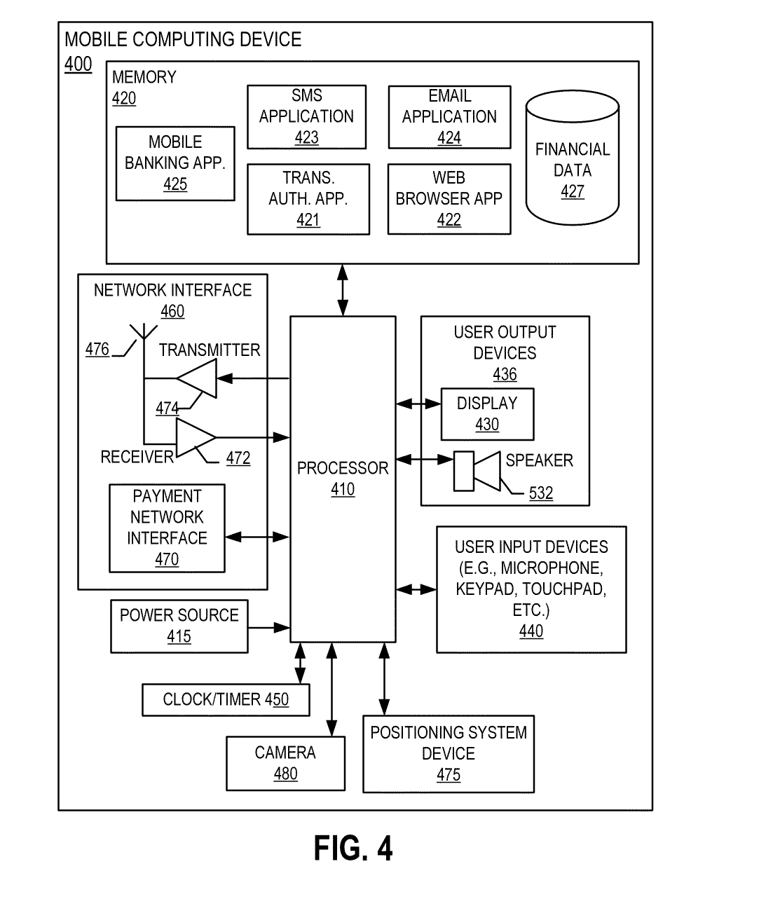

The mobile computing device 400, financial institution computer system 500, and point of transaction computer system 600 are each configured to communicate with each other over a network 350. The mobile computing device 400, financial institution computer system 600, and point of transaction computer system 600 and are each described in greater detail below with reference to FIGS. 4-6. The network 350 may include a local area network (LAN), a wide area network (WAN), a global area network (GAN), near field communication network, bluetooth network or any other type of communications network or protocol. In some embodiments, network 350 may comprise the Internet. In addition, network 350 may include first, second, third, and/or fourth-generation cellular communication networks and/or the like. For example, the network 350 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network 350 may provide for wireline, wireless, or a combination of wireline and wireless communication between devices in the network.

In the embodiment of the invention depicted in FIG. 3, network 350 comprises near field communication (“NFC”) network 355, cellular network 360, and Internet 365. In some embodiments of the invention, mobile computing device 400 communicates with point of transaction computer system 500 over near field communication network 355. For example, mobile computing device 400 may communicate with point of transaction computer system 600 when mobile computing device 400 commences a transaction, as described in relation to block 210 of FIG. 2, and/or when mobile computing device 400 otherwise sends or receives information to/from point of transaction computer system 600. For instance, in some embodiments of the invention, mobile computing device 400 receives a request to verify a transaction from point of transaction computer system 600. Furthermore, in some embodiments, mobile computing device 400 sends indicia (or an indication that indicia is correct or not) to point of transaction computer system 600.

In some embodiments, point of transaction computer system 600 communicates with financial institution computer system 500 via Internet 365. For example, point of transaction computer system 600 may communicate with financial transaction computer system 500 when point of transaction computer system 600 uses indicia to verify the transaction, as described in relation to block 235 of FIG. 2, and/or when point of transaction computer system 600 otherwise sends or receives information to/from financial institution computer system 500.

Although in the embodiment of the invention depicted in FIG. 3, point of transaction computer system 600 comprises a payment terminal, in some other embodiments of the invention (which are not depicted in FIG. 3), the payment terminal may be a separate device from point of transaction computer system 600. In those embodiments, mobile computing device 400 may similarly communicate with the payment terminal via network 350. Additionally, the payment terminal may communicate with point of transaction computer system 600 via network 350.

Referring now to FIG. 4, the mobile computing device 400 associated with the user 302 is described. FIG. 4 provides a block diagram illustrating mobile computing device 400 in accordance with embodiments of the invention. In one embodiment of the invention, the mobile computing device 400 is a mobile telephone. However, it should be understood, however, that a mobile telephone is merely illustrative of one type of mobile computing device 400 that may benefit from, employ, or otherwise be involved with embodiments of the present invention and, therefore, should not be taken to limit the scope of embodiments of the present invention. Other types of mobile computing devices 400 may include portable digital assistants (PDAs), pagers, mobile televisions, gaming devices, laptop computers, cameras, video recorders, audio/video player, radio, GPS devices, or any combination of the aforementioned.

The mobile computing device 400 generally includes a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the mobile computing device 400. For example, the processor 410 may include a digital signal processor device, a microprocessor device, and various analog to digital converters, digital to analog converters, and/or other support circuits. Control and signal processing functions of the mobile computing device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile computing device 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 350. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. In some embodiments where network 350 is a wireless telephone network, the signals may include signaling information in accordance with the air interface standard of the applicable cellular system of the wireless telephone network. In this regard, the mobile computing device 400 may be configured to operate with one or more air interface standards, communication protocols, modulation types, and access types. By way of illustration, the mobile computing device 400 may be configured to operate in accordance with any of a number of first, second, third, and/or fourth-generation communication protocols and/or the like. For example, the mobile computing device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile computing device 400 may also be configured to operate in accordance with non-cellular communication mechanisms, such as via a wireless local area network (WLAN), near field communication network, or other communication/data networks.

The network interface 460 may also include a payment network interface 470. The payment network interface 470 may include software, such as encryption software, and hardware, such as a modem, for communicating information to and/or from one or more devices on a network 350. For example, the mobile computing device 400 may be configured so that it can be used as a credit or debit card by, for example, wirelessly communicating account numbers or other verification information to point of transaction computer system 500.

As described above, the mobile computing device 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile computing device 400 to receive data from user 402, may include any of a number of devices allowing the mobile computing device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile computing device 400 may also include a positioning system device 475 that is configured to be used by a positioning system to determine a location of the mobile computing device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile computing device 400. In other embodiments, the positioning system device 475 includes a proximity sensor or transmitter, such as an RFID tag, that can sense or be sensed by devices known to be located proximate a merchant or other location to determine that the consumer mobile computing device 400 is located proximate these known devices.

The mobile computing device 400 further includes a power source 415, such as a battery, for powering various circuits and other devices that are used to operate the mobile computing device 400. Embodiments of the mobile computing device 400 may also include a clock or other timer 450 configured to determine and, in some cases, communicate actual or relative time to the processor 410 or one or more other devices.

The mobile computing device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile computing device 400 described herein. For example, the memory 420 may include such applications as a transaction verification application 421, conventional web browser application 422, a SMS application 423, and email application 424 and/or mobile banking application 425. These applications also typically provide a graphical user interface (GUI) on the display 430 that allows user 302 to communicate with point of transaction computer system 600 and/or financial institution computer system 500. In some embodiments, memory 420 may store financial data 427. Financial data 427 may comprise and data or information relating to transactions of a user, such as credit card information, debit card information, bank account information, and/or information necessary to validate transactions involving the user. In some embodiments, financial data 427 may include the stored information that will be compared to user's inputted indicia to determine if a transaction should be verified.

The memory 420 can also store any of a number of pieces of information, and data, used by the mobile computing device 400 and the applications and devices that make up the mobile computing device 400 or are in communication with the mobile computing device 400 to implement the functions of the mobile computing device 400 and/or the other systems described herein. For example, the memory 420 may include stored data that may be used to verify a user's indicia, etc. to complete a transaction.

As used herein, a “processor” (such as the processor 410) or a “processing device,” generally refers to a device or combination of devices having circuitry used for implementing the communication and/or logic functions of a particular system. For example, a processor 410 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor 410 may further include functionality to operate one or more software programs based on computer-executable program code thereof, which may be stored in a memory. As the phrase is used herein, a processor 410 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory” (such as memory 420) or “memory device,” generally refers to a device or combination of devices that store one or more forms of computer-readable media for storing data and/or computer-executable program code/instructions. Computer-readable media is defined in greater detail below. For example, in one embodiment, the memory 420 includes any computer memory that provides an actual or virtual space to temporarily or permanently store data and/or commands provided to the processor 410 when it carries out its functions described herein.

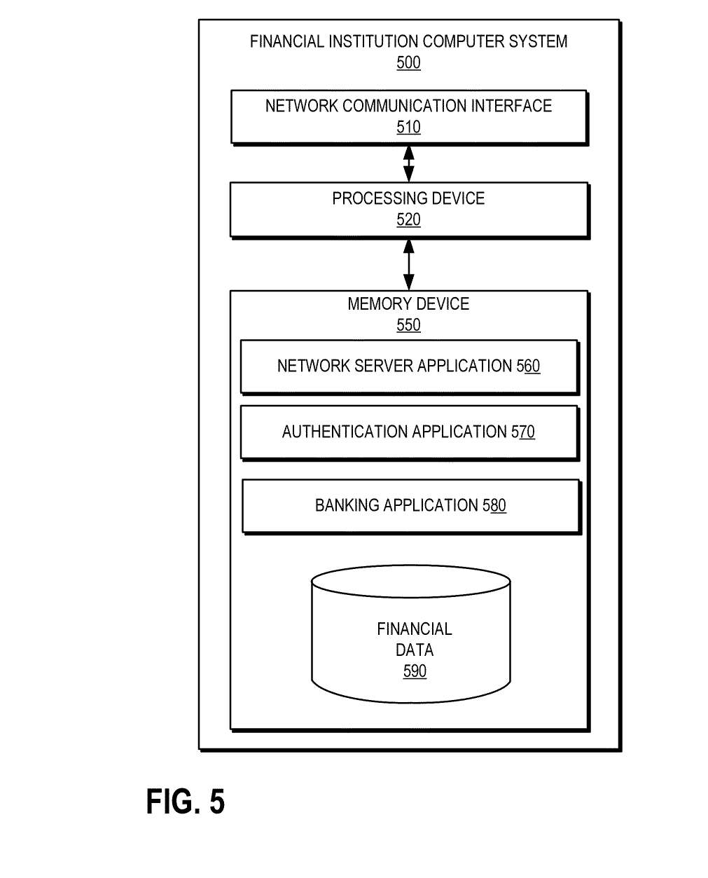

FIG. 5 provides a block diagram illustrating the financial institution computer system 500 in greater detail, in accordance with an embodiment of the invention. As illustrated in FIG. 5, in one embodiment of the invention, the financial institution computer system 500 includes a processing device 520 operatively coupled to a network communication interface 510 and a memory device 550. In certain embodiments, the financial institution computer system 500 is operated by a first entity, such as a financial institution, while in other embodiments, the financial institution computer system 500 is operated by an entity other than a financial institution.

It should be understood that the memory device 550 may include one or more databases or other data structures/repositories. The memory device 550 also includes computer-executable program code that instructs the processing device 520 to operate the network communication interface 510 to perform certain communication functions of the financial institution computer system 500 described herein. For example, in one embodiment of the financial institution computer system 500, the memory device 550 includes, but is not limited to, a network server application 560, a verification application 570, banking application 580, and other computer-executable instructions or other data. In some embodiments of the invention, verification application 570 performs the task of verifying indicia by comparing the indicia to stored information. The computer-executable program code of the network server application 560, the verification application 570, or the banking application 580 may instruct the processing device 520 to perform certain logic, data-processing, and data-storing functions of the financial institution computer system 500 described herein, as well as communication functions of the financial institution computer system 500.

In one embodiment, memory device 550 includes financial data 590. Financial data 590 may comprise data or information relating to transactions of a user, such as credit card information, debit card information, bank account information, and/or information necessary to validate transactions involving the user. In some embodiments, financial data 590 may include the stored information that will be compared to user inputted indicia to determine if a transaction should be verified. The network server application 560, the verification application 570, and/or the banking application 580 are configured to access financial data 590 when configured to perform the steps of the present invention.

While the embodiment of the invention depicted in FIG. 5 indicates that financial data 590 is stored in memory device 550 of financial institution computer system 500, in other embodiments of the invention, financial data 590 may be stored in memory devices in other computer systems, including computer systems operated by third parties. In such embodiments, financial institution computer system may still access the financial data 590 through the use of network communication interface 510.

As used herein, a “communication interface” generally includes a modem, server, transceiver, and/or other device for communicating with other devices on a network, and/or a user interface for communicating with one or more customers. Referring again to FIG. 5, the network communication interface 510 is a communication interface having one or more communication devices configured to communicate with one or more other devices on the network 350, such as the mobile computing device 400 and point of transaction computer system 600. The processing device 520 is configured to use the network communication interface 510 to transmit and/or receive data and/or commands to and/or from the other devices connected to the network 350.

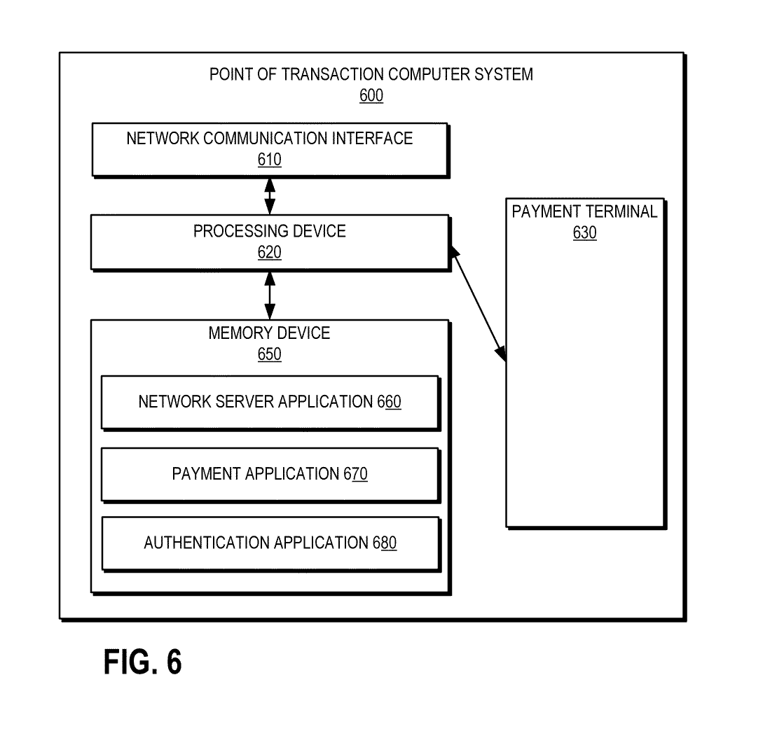

FIG. 6 provides a block diagram illustrating the point of transaction computer system 600 in greater detail, in accordance with an embodiment of the invention. As illustrated in FIG. 6, in one embodiment of the invention, the point of transaction computer system 600 includes a processing device 620 operatively coupled to a network communication interface 610 and a memory device 650. In certain embodiments, the financial institution computer system 600 is operated by a merchant or other commercial entity that may enter into transactions with the user.

It should be understood that the memory device 650 may include one or more databases or other data structures/repositories. The memory device 650 also includes computer-executable program code that instructs the processing device 620 to operate the network communication interface 610 to perform certain communication functions of the point of transaction computer system 600 described herein. For example, in one embodiment of the point of transaction computer system 600, the memory device 650 includes, but is not limited to, a network server application 660, payment application 670 and a verification application 680. The computer-executable program code of the network server application 660, the payment application 670, or the verification application 680 may instruct the processing device 620 to perform certain logic, data-processing, and data-storing functions of the point of transaction computer system 600 described herein, as well as communication functions of the point of transaction computer system 600. In some embodiments, point of transaction computer system 600 may execute payment application 670 to initiate functionality configured to conduct a transaction, such as initiating the functionality that allows a near field communication payment terminal to conduct transactions with a user's mobile phone. Additionally, in some embodiments, point of transaction computer system 600 may execute verification application 680 to perform the functionality configured to verify a transaction, such as receiving indicia from a mobile computing device.

Additionally, as illustrated in FIG. 6, point of transaction computer system 600 also includes payment terminal 630 operatively coupled to processing device 620. In this embodiment of the invention, payment terminal 630 is a NFC payment terminal that allows mobile device 400 to conduct financial transactions using e-wallet functionality. In this embodiment of the invention, payment terminal 630 may be located external to the rest of transaction computer system 600. Although not depicted in FIG. 6, in some embodiments of the invention, payment terminal 630 may include a processor, memory device, and communication interface. In some embodiments of the invention, payment terminal 630 may communicate with mobile device 400 over network 350 independent of network communication interface 610 and in some of these embodiments, information received by payment terminal 630 may be transmitted by network communication interface 610.

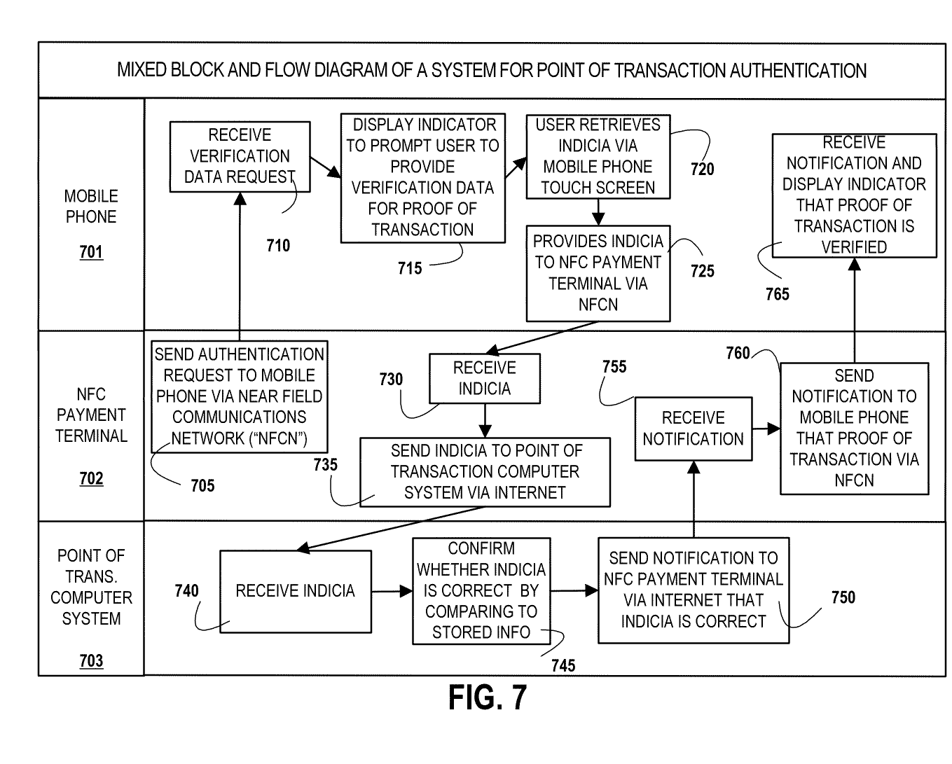

Referring now to FIG. 7, a mixed block and flow diagram of a system 700 for verifying a transaction at a point of transaction. In general terms, FIG. 7 illustrates an embodiments of the invention in which the user uses a mobile phone 701 to verify a transaction at a near field communication payment terminal 702 (“NFC payment terminal 702”). Mobile phone 701 is one embodiment of mobile computing device 400 and NFC payment terminal 702 is one embodiment of payment terminal 630 that is operatively connected to point of transaction computer system 600. Additionally, it will be understood that the mixed block and flow diagram of a system 700 in FIG. 7 represents an embodiment of process flow 100 and process flow 200. As one of ordinary skill in the art will recognize, in this embodiment, where NFC payment terminal 702 is operatively connected to a point of transaction computer system, sending/receiving information or data to/from NFC payment terminal 702 may also comprise sending/receiving information or data to/from the point of transaction computer system.

It will be understood that FIG. 7 depicts a process flow in which a user is using mobile phone 701 to conduct a return transaction at NFC payment terminal 702. In the embodiment of the invention depicted at FIG. 7, the user is at a grocery store and is seeking to return a purchase of groceries by providing an electronic receipt at NFC payment terminal 702. The user has already commenced the transaction by tapping the user's mobile phone 701 against the NFC payment terminal 702 and user has already provided the proof of transaction information. Point of transaction computer system 703 is maintained by the point of transaction that manages the NFC payment terminal. The NFC payment terminal 702 also has the capabilities to process a return of a good or service previously purchased, exchange a good or service previously purchased, or reverse a previous transaction by the user.

As represented in block 705, after the user has used mobile phone 701 to commence the return groceries, NFC payment terminal 702 sends an verification request to mobile phone 701 via near field communications network. The NFC payment terminal 701 sends the verification request in order to verify that the proof of transaction information provided by the user for returning the purchase of groceries is authentic. At block 710, mobile phone 701 receives the verification request from NFC payment terminal 702.

At block 715, mobile phone 701 displays an indicator prompting the user to provide proof of transaction verification data. In this embodiment, the indicator appears as a graphic on the display of mobile phone 701 which prompts the user to provide proof of transaction verification data. As one of skill in the art will appreciate, the indication can contain any type of text, images, and/or both in order to indicate to prompt the user to provide proof of transaction verification data. In some other embodiments of the invention, mobile phone 701 may additionally or alternatively prompt the user by using sounds or making the phone vibrate.

As represented in block 720, after viewing the indicator, the user retrieves the indicia associated with the proof of transaction via the touch screen of mobile phone 701. In other embodiments of the invention, the user could use a keypad to retrieve the indicia associated with the proof of transaction. In this embodiment of the invention, the user retrieves the indicia associated with the proof of transaction in order to verify the proof of transaction information presented to the grocer.

At block 725, after retrieving the indicia associated with the proof of transaction at block 720, mobile phone 701 provides the indicia to NFC payment terminal 702 via the near field communications network. As represented in block 730, NFC payment terminal 702 receives the indicia from mobile phone 701. Subsequently, at block 735, NFC payment terminal 702 sends the indicia to the point of transaction computer system 703 via the Internet. In some embodiments, NFC payment terminal 702 sends the indicia to point of transaction computer system 703 via the functionality of the NFC payment terminal (to which NFC payment terminal 703 is operatively connected). In some embodiments of the invention, the NFC payment terminal 702 accesses the Internet via a wireless network, wireline network and/or a combination of both. At block 740, point of transaction computer system 703 receives the indicia from NFC payment terminal 702.

In an alternative embodiment at block 725, after retrieving the indicia associated with the proof of transaction at block 720, mobile phone 701 provides the indicia as a bar code readable by the payment terminal 702 via a display of mobile phone 701. Subsequently, at block 730, NFC payment terminal 702 would receive the indicia via a bar code scanning device. Following, the NFC payment terminal 702 sends the indicia to point of transaction computer system 703 via the functionality of the NFC payment terminal in order to retrieve the transaction associated with the proof of transaction information and/or the indicia.

As represented in FIG. 7, in block 745, the point of transaction computer system 703 compares the indicia that it received at block 740 to stored information. In this embodiment of the invention, the stored information is a second indicia that is associated with the user's proof of transaction. In this embodiment of the invention, the second indicia that is associated with the user's electronic receipt is stored in the memory of point of transaction computer system 703, and point of transaction computer system compares the indicia it received at block 740 to the stored, second indicia. As indicated at block 745, the point of transaction computer system 703 confirms that the indicia received at block 740 is correct because it matches the stored second indicia.

At block 750, point of transaction computer system 703 sends a notification to NFC payment terminal 702 (via the functionality of a point of transaction computer system to which NFC payment terminal 703 is operatively connected) that the indicia that the user provided at step 720 is correct. Point of transaction computer system 703 sends this notification via the Internet. Point of transaction computer system 703 accesses the Internet via a wireless network, wireline network and/or a combination of both. At block 755, NFC payment terminal 702 receives the notification that indicia that the user provided at block 720 is valid (via the functionality of a point of transaction computer system to which NFC payment terminal 703 is operatively connected). Subsequently, at block 760, the NFC payment terminal 702 sends a notification to mobile phone 701 via the near field communication network that the proof of transaction is verified. The proof of transaction is verified because the indicia that the user provided at block 720 matches the stored information from block 745.

In other embodiments of block 750, point of transaction computer system 703 may also send a notification directly to mobile phone 701 that the indicia that the user provided at step 720 is correct. Point of transaction computer system 703 may send this notification via a cellular network. In such embodiments, where point of transaction computer system 703 also sends a notification to mobile phone 701, the process flow would omit block 760.

At block 765, mobile phone 701 receives the notification from NFC payment terminal 702. Additionally, at block 765, mobile phone 701 displays an indicator that indicates that the proof of transaction has been verified. In this embodiment, the indicator appears as a graphic on the display of mobile phone 701 which indicates to the user that the proof of transaction has been verified. As one of skill in the art will appreciate, the indication can contain any type of text, images, and/or both in order to indicate to the user that the proof of transaction has been verified. In some other embodiments of the invention, mobile phone 701 may additionally or alternatively indicate that the proof of transaction has been verified by using sounds or making the phone vibrate. Once the user receives the indication that the proof of transaction has been verified at block 765, the user is able to leave the grocery store with a credit or money received from the groceries items returned through the use of mobile phone 701.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for verifying proof of transaction information, said system comprising:
a communication interface;
a storage device comprising verification data comprising an indicia associated with transaction information, wherein the indicia is used to verify proof of transaction information; and
a processing device in communication with said communication interface and said storage device, wherein said processing device is configured to:
retrieve the indicia associated with transaction information from said storage device; and
provide information associated with the indicia to said communication interface for output to thereby verify the proof of transaction information associated with the indicia;

2. The system of claim 1, wherein communication interface is a mobile computing device.

3. The system of claim 1, wherein the storage device comprises a plurality of indicia associated with a plurality of transactions.

4. The system of claim 1, wherein the proof of transaction information comprises an electronic receipt.

5. The system of claim 1, wherein the proof of transaction information comprises an electronic receipt.

6. The system of claim 1, wherein the proof of transaction information further comprises information about a user and merchant associated with the transaction.

7. The system of claim 1, wherein the storage device comprises a cloud data base associated with a user.

8. The system of claim 1, wherein the processing device is further configured to use the indicia to generate a barcode and use the communication interface to display the barcode readable by a point of transaction device, wherein the barcode comprises, at least, the indicia.

9. The system of claim 1, wherein the processing device is further configured to use the indicia to render a media file and use the communication interface to display the media file readable by a point of transaction device, wherein the media file comprises, at the least, the indicia.

10. The system of claim 8, wherein contents of the media file are identifiable by a person.

11. The system of claim 1, wherein the processing device is configured to use the communication interface to display the proof of transaction information with the indicia appended therewith.

12. The system of claim 1, wherein the processing device is configured to use the communication interface to display a rendering of a media file comprising the indicia readable by a point of transaction device.

13. The system of claim 1, wherein the processing device is configured to use the communication interface to output a communication comprising the indicia wirelessly to the point of transaction.

14. The system of claim 1, wherein the indicia associated with a transaction comprises a unique identifier used to identify the transaction.

15. The system of claim 1, wherein the indicia associated with a transaction comprises portions of verification data extracted from the proof of transaction information.

16. A method for maintaining and presenting proof of transaction information, said method comprising:
providing information associated with a proof of transaction information;
receiving a prompt for a user to provide verification data associated with the proof of transaction information;
retrieving, using a processing device, an indicia associated with the proof of transaction information; and
providing the indicia associated with proof of transaction information for verification.

17. The method of claim 14, wherein the providing information associated with a proof of transaction information comprises providing information associated with a proof of transaction via a wireless network.

18. The method of claim 14, wherein the receiving a prompt for a user to provide verification data associated with the proof of transaction information comprises receiving the prompt for the user to provide verification data associated with the proof of transaction information at a user's mobile computing device.

19. The method of claim 14, wherein the retrieving, using a processing device, an indicia associated with the proof of transaction information comprises retrieving the indicia associated with the proof of transaction information from a financial institution's system.

20. The method of claim 17, wherein the financial institution's system comprises a proof of transaction management system and a database, wherein proof of transaction information and indicia associated with transactions involving user's are stored.

21. The method of claim 14, wherein the providing the indicia with proof of transaction information for verification comprises providing the indicia with proof of transaction information for verification to a point of transaction device.

22. The method of claim 14, wherein the information associated with a proof of transaction comprises and electronic receipt.

23. The method of claim 14, wherein providing the indicia associated with proof of transaction information for verification comprises generating a barcode for display readable by a point of transaction device, wherein the barcode comprises, at least, the indicia.

24. The method of claim 14, wherein providing the indicia associated with proof of transaction information for verification comprises rendering a media file readable by a point of transaction device, wherein the media file comprises, at least, the indicia.

25. The method of claim 14, further comprising:
providing to a point of transaction device an electronic signature to thereby complete the transaction.

26. A computer program product comprising a non-transitory computer readable medium, wherein the non-transitory computer readable medium comprises one or more computer-executable program code portions that, when executed by a computer, cause the computer to:
provide information associated with a proof of transaction information;
receive a prompt for a user to provide verification data associated with the proof of transaction information;
retrieve an indicia associated with the proof of transaction information; and
provide the indicia associated with the proof of transaction information for verification.

27. The computer program product of claim 23, wherein the one or more computer-executable program code portions, when executed by the computer, cause the computer to:
provide the indicia associated with the proof of transaction information for verification by generating a barcode readable by a point of transaction device.

28. The computer program product of claim 23, wherein the one or more computer-executable program code portions, when executed by the computer, cause the computer to:
provide the indicia associated with the proof of transaction information for verification by rendering a media file readable by a point of transaction device.
